(19) United States
(12) Patent Application Publication
(10) Pub. No.: US 2013/0126741 A1
(43) Pub. Date: May 23, 2013

(54) Ce3+ ACTIVATED MIXED HALIDE ELPASOLITES AND HIGH ENERGY RESOLUTION SCINTILLATOR

(71) Applicant: General Electric Company, Schenectady, NY (US)

(72) Inventors: Alok Mani SRIVASTAVA, Niskayuna, NY (US); Holly Ann COMANZO, Niskayuna, NY (US); Venkat Subramaniam VENKATARAMANI, Niskayuna, NY (US); Steven Jude DUCLOS, Clifton Park, NY (US); Lucas Lemar CLARKE, Bradenton, FL (US); Qun DENG, Shanghai (CN)

(73) Assignee: GENERAL ELECTRIC COMPANY, Schenectady, NY (US)

(21) Appl. No.: 13/682,395

(22) Filed: Nov. 20, 2012

(30) Foreign Application Priority Data
Nov. 23, 2011 (CN) 201110462507.5

(51) Int. Cl. C09K 11/77; G01T 1/20

(52) U.S. Cl. CPC C09K 11/7773; G01T 1/2006
USPC 250/362; 250/361 R; 252/301.4 H

(57) ABSTRACT

A scintillator composition is described. The scintillator composition includes a matrix material and an activator. The matrix material includes at least one alkali metal or thallium; at least one alkali metal, different than the previously selected alkali metal; at least one lanthanides; and at least two halogens. The activator is cerium. Further, radiation detectors, which include the scintillator composition and methods for detecting high-energy radiation are also described and form part of this disclosure.

### BACKGROUND OF THE INVENTION

Embodiments of the subject matter disclosed herein generally relate to scintillator compounds, and more particularly, to Ce3+ activated mixed halide elpasolites.

Scintillator materials are in common use as a component of radiation detectors for gamma-rays, X-rays, cosmic rays and particles characterized by an energy level of greater than about 1 keV. The scintillator crystal is coupled with a light-detection means, that is, a photodetector. When photons from a radionuclide source impact the crystal, the crystal emits light. The photodetector produces an electrical signal proportional to the number of light pulses received, and to their intensity.

Scintillators have been found to be useful for applications in chemistry, physics, geology and medicine. Specific examples of the applications include positron emission tomography (PET) devices, well-logging for the oil and gas industry and various digital imaging applications. Scintillators are also being investigated for use in detectors for security devices, for example, detectors for radiation sources which may indicate the presence of radioactive materials in cargo containers.

For all of these applications, the composition of the scintillator is related to device performance. The scintillator needs to be responsive to X-ray and gamma ray excitation. Moreover, the scintillator should possess a number of characteristics which enhance radiation detection. For example, most scintillator materials possess high light output, short decay time, high “stopping power,” and acceptable energy resolution. Further, other properties can also be relevant, depending on how the scintillator is used, as mentioned below.

Various scintillator materials which possess most or all of these properties have been in use over the years. Examples include thallium-activated sodium iodide (NaI(Tl)); bismuth germinate (BGO); cerium-doped gadolinium orthosilicate (GSO); cerium-doped lutetium orthosilicate (LSO); and cerium-activated lanthanide-halide compounds. Each of these materials has properties which are suitable for certain applications. However, many of them also have some drawbacks. The common problems are low light yield, physical weakness, and the inability to produce large-size, high quality single crystals. Other drawbacks are also present. For example, the thallium-activated materials are very hygroscopic, and can also produce a large and persistent after-glow, which can interfere with scintillator function. Moreover, the BGO materials suffer from slow decay time and low light output. On the other hand, the LSO materials are expensive, and may also contain radioactive lutetium isotopes which can also interfere with scintillator function.

In general, those interested in obtaining the optimum scintillator composition for a radiation detector have been able to review the various attributes set forth above, and thereby select the best composition for a particular device. For example, scintillator compositions for well-logging applications need to be able to function at high temperatures, while scintillators for positron emission tomography devices need often exhibit high stopping power. However, the required overall performance level for most scintillators continues to rise with the increasing sophistication and diversity of all radiation detectors.

It should thus be apparent that new scintillator materials would be of considerable interest if they could satisfy the ever-increasing demands for commercial and industrial use. The materials should exhibit excellent light output. They should also possess one or more other desirable characteristics, such as relatively fast decay times and good energy resolution characteristics, especially in the case of gamma rays. Furthermore, they should be capable of being produced efficiently, at reasonable cost and acceptable crystal size.

### BRIEF DESCRIPTION OF THE INVENTION

According to an exemplary embodiment, there is provided a scintillator composition. The scintillator composition includes any reaction products, and also includes a matrix material and an activator for the matrix material. The matrix material comprises a first component of at least one element selected from the group consisting of alkali metals and thallium, a second component of at least one element, different from the element of the first component, selected from the group consisting of alkali metals, a third component of at least one element selected from the group consisting of lanthanides and a fourth component of at least two elements selected from the group consisting of halogens. The activator for the matrix material comprises cerium.

According to another exemplary embodiment, there is provided a radiation detector apparatus for detecting high-energy radiation. The apparatus includes a crystal scintillator. The crystal scintillator comprises the following composition, and any reaction products thereof: a matrix material, an activator and a photodetector optically coupled to the crystal scintillator and configured to produce an electrical signal in response to the emission of a light pulse produced by the scintillator. The matrix material comprises a first component of at least one element selected from the group consisting of alkali metals and thallium, a second component of at least one element, different from the element of the first component, selected from the group consisting of alkali metals, a third component of at least one element selected from the group consisting of lanthanides, and a fourth component of at least two elements selected from the group consisting of halogens. The activator for the matrix material comprises cerium.

According to yet another exemplary embodiment, there is provided a method for detecting high-energy radiation with a scintillator detector. The method comprises receiving radiation by a scintillator crystal so as to produce photons which are characteristic of the radiation and detecting the photons with a photon detector coupled to the scintillator crystal. The scintillator crystal is formed of a composition comprising the following, and any reaction products thereof: a matrix material and an activator for the matrix material. The matrix material comprises a first component of at least one element selected from the group consisting of alkali metals and thallium, a second component of at least one element, different from the element of the first component, selected from the group consisting of alkali metals, a third component of at least one element selected from the group consisting of lanthanides, and a fourth component of at least two elements selected from the group consisting of halogens. The activator for the matrix material comprises cerium.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is an exemplary embodiment of an elpasolite scintillator composition;

FIG. 2 is an exemplary embodiment of a radiation detector combining an elpasolite scintillator composition crystal and a photodetector;

FIG. 3 is an exemplary embodiment flowchart illustrating steps for detecting high-energy radiation with a scintillator detector; and

FIG. 4 is an exemplary embodiment graph of the emission spectrum (under X-ray excitation), for a scintillator composition according to an exemplary embodiment.

### DETAILED DESCRIPTION OF THE EXEMPLARY EMBODIMENTS OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of high energy resolution scintillating Elpasolite compounds.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

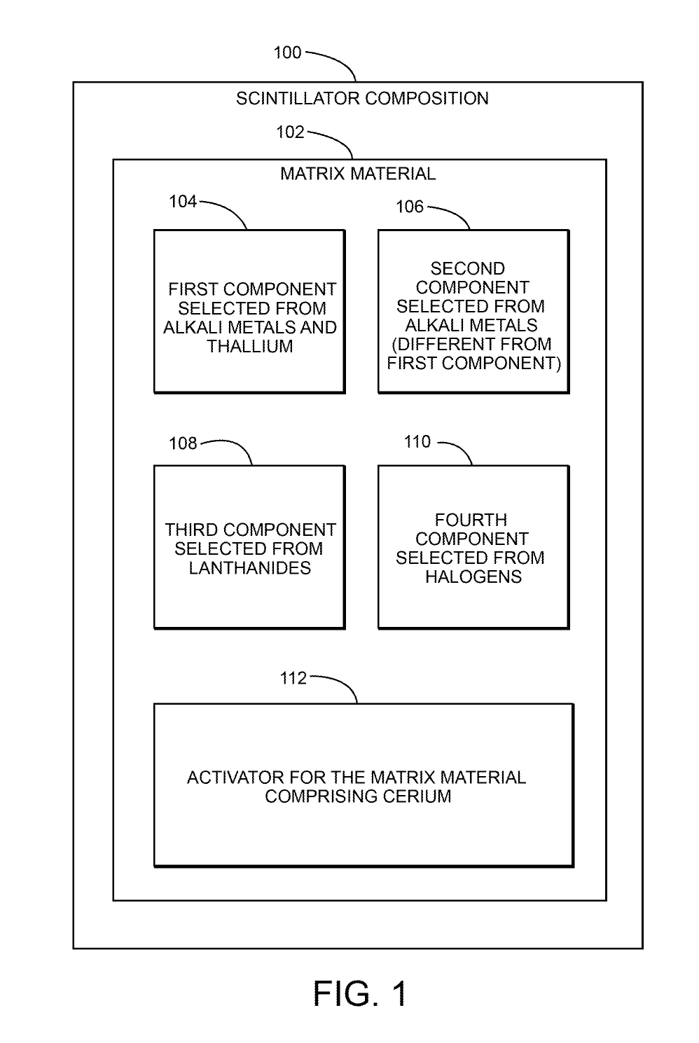

Looking now to FIG. 1, an exemplary embodiment of scintillator compositions 100 based on a host lattice (matrix material) 102 with the Elpasolite crystal structure and with the general formulation of A₂BLnX₆ where A 104 is one or more of a Group 1A element of Potassium (K), Rubidium (Rb), Cesium (Cs) and Thallium (Tl); B 106 is one or more of a Group 1A element of Lithium (Li) and Sodium (Na); X 110 is one or more of Fluorine (F), Chlorine (Cl), Bromine (Br) and Iodine (I); and Ln 108 is a lanthanide. In all cases of the exemplary embodiments, the scintillator composition 100 uses a trivalent Cerium ion (Ce3+) activator 112 to produce efficient luminescence under Ultraviolet, X-ray and gamma-ray excitation. In a further aspect of the exemplary embodiments, the trivalent Cerium ion (Ce3+) can be combined with one or more of univalent Thallium (Tl+) and trivalent Bismuth (Bi3+) to increase the density and accordingly, the stopping power of the scintillator composition 100. In another aspect of the exemplary embodiment, such “doping” of the trivalent Cerium allows for the manufacture of thinner crystals with the same stopping power as a thicker non-doped crystal. In another aspect of the exemplary embodiment, the addition of the univalent Thallium (Tl+) ion and the trivalent Bismuth (Bi3+) ion is predicted to improve the light output by decreasing the band gap.

As an example, the light output (LO) of Ce3+ activated LaBr₃ and LaCl₃ are 61,000 and 46,000 photons per MeV respectively. According, the exemplary embodiments provide an energy resolution of 2.85% for LaBr₃ and 3.30% for LaCl₃. Providing the unexpected results of greater efficiency for a mixed halide over a single halide is the exemplary scintillator composition 100 of the Elpasolite, Cs₂NaLaBr₄I₂. It was expected that a particular halide would have the greatest efficiency and that mixing halides would reduce the efficiency based on the type and number of halides involved, that is, efficiency somewhere between the efficiencies of the individual halides. In a result of this exemplary embodiment, counter to this prediction, a mixture of halides of four Bromine ions and two Iodine ions produced efficiency greater than either of the individual halides when used alone in the scintillator composition 100.

The proposed scintillator compositions 100 in the exemplary embodiment will have a light output (LO) exceeding that of commercially available materials such as bismuth germinate (BGO) and cerium-doped lutetium orthosilicate (LSO). Further in the exemplary embodiment, the proposed scintillator compositions 100 would considerably enhance the ability to discriminate between gamma rays of slightly different energies.

Continuing with the exemplary embodiment, the appropriate level of the activator 112 will depend on various factors, such as the particular halides 110 and group “A” 104 and “B” 106 elements present in the matrix material 102; the desired emission properties and decay time; and the type of detection device into which the scintillator composition 100 is being incorporated. Usually in the exemplary embodiments, the activator 112 (Ce3+) is employed at a level in the range of about 1 mole percent to about 100 mole percent, based on total moles of activator 112 and matrix material 102. In many preferred embodiments, the amount of activator 112 is in the range of about 1 mole percent to about 30 mole percent on the same basis.

Further, it should be noted in the exemplary embodiment that the scintillator compositions 100 are usually described in terms of a matrix material 102 component and an activator 112 component. However, it should be noted in the exemplary embodiment that when the components are combined, they can be considered as a single, intimately-mixed composition, which still retains the attributes of the activator 112 component and the matrix material 102 component. For example, an illustrative scintillator composition 100 can be expressed as Cs₂NaLa_{0.98}Ce_{0.02}Br₄I₂.

In some exemplary embodiments, the matrix material 102 can further comprise bismuth. The presence of bismuth in an exemplary embodiment can enhance various properties such as but not limited to stopping power. The amount of bismuth, when present, in an exemplary embodiment can vary to some extent. Exemplary amounts can range from about 1 mole percent to about 40 mole percent of the total molar weight of the matrix material, including the bismuth.

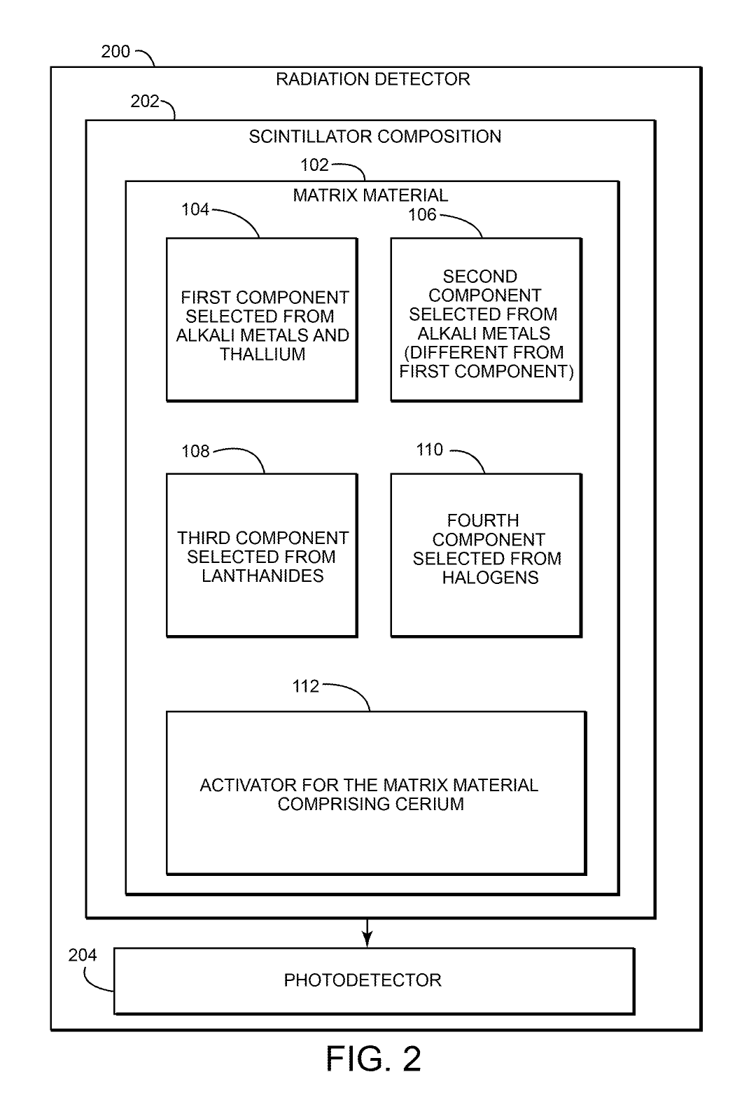

Continuing with the exemplary embodiments, the scintillator compositions 100 can be prepared and used in various forms. For example, in some embodiments the scintillator composition 100 is in monocrystalline (single crystal) form. It should be noted in the exemplary embodiments that monocrystalline scintillator composition 100 crystals have a greater tendency for transparency and are especially useful for high-energy radiation detectors 200 (see FIG. 2) such as those used to detect gamma rays.

In some exemplary embodiments, the scintillator composition 100 can be used in other forms as well, depending on its intended end use. For example, the scintillator composition 100 can be in a powder form. It should be noted in the exemplary embodiments that the scintillator compositions 100 may contain small amounts of impurities as described in publications WO 01/60944 A2 and WO 01/60945 A2, incorporated herein by reference. These impurities usually originate with the starting components and typically constitute less than about 0.1% by weight, of the scintillator composition 100, and can be as little as 0.01% by weight. It should further be noted in the exemplary embodiment that the scintillator composition 100 may also include parasitic additives, whose volume percentage is usually less than about 1%. Moreover in the exemplary embodiment, minor amounts of other materials may be purposefully included in the scintillator compositions 100.

A variety of techniques can be used for the preparation of the exemplary embodiment scintillator compositions 100. In an exemplary embodiment, a suitable powder containing the desired materials in the correct proportions is first prepared, followed by such operations as calcination, die forming, sintering and/or hot isostatic pressing. The exemplary embodiment suitable powder can be prepared by mixing various forms of the reactants, for example, salts, halides or mixtures thereof. In some cases, individual constituents are used in combined form, for example, commercially available in the combined form. For example, various halides of the alkali metals and alkaline earth metals could be used. Non-limiting examples of these compounds include cesium chloride, potassium bromide, cesium bromide, cesium iodide and the like.

In the exemplary embodiment, the mixing of the reactants can be carried out by any suitable techniques which ensure thorough, uniform blending. For example, mixing can be carried out in an agate mortar and pestle. As an alternative exemplary embodiment, a blender or pulverization apparatus, such as a ball mill, bowl mill, hammer mill or a jet mill can be used. Continuing with the exemplary embodiment, the mixture can also contain various additives, such as fluxing compounds and binders and depending on compatibility and/or solubility, various liquids can sometimes be used as a vehicle during milling. It should be noted in the exemplary embodiment that suitable milling media should be used, that is, material that would not be contaminating to the scintillator composition 100, since such contamination could reduce its light-emitting capability.

Next in the exemplary embodiment, the mixture can be fired under temperature and time conditions sufficient to convert the mixture into a solid solution. The conditions required in the exemplary embodiments will depend in part on the specific reactants selected. The exemplary embodiment mixture is typically contained in a sealed vessel, such as a tube or crucible made of quartz or silver, during firing so that none of the constituents are lost to the atmosphere. An exemplary embodiment firing will usually be carried out in a furnace at a temperature in the range of about 500° C. to about 1,500° C. with a firing time typically ranging from about 15 minutes to about 10 hours. An exemplary embodiment firing is typically carried out in an atmosphere free of oxygen and moisture, for example, in a vacuum or under an inert gas such as but not limited to nitrogen, helium, neon, argon, krypton and xenon. After firing of the exemplary embodiment scintillator composition 100, the resulting material can be pulverized to place the scintillator composition 100 into a powder form and conventional techniques can be used to process the powder into radiation detector elements.

In another aspect of the exemplary embodiment, a single crystal material can be prepared by techniques well known in the art. A non-limiting, exemplary reference is “Luminescent Materials” by G. Blasse et. al., Springer-Verlag (1994). Typically, in an exemplary embodiment, appropriate reactants are melted at a temperature sufficient to form a congruent, molten composition.

Continuing with the exemplary embodiment, a variety of techniques can be employed to prepare a single crystal of the scintillator composition 100 from a molten composition, described in references such as, but not limited to U.S. Pat. No. 6,437,336 (Pauwels et. al.) and “Crystal Growth Processes,” by J. C. Brice, Blackie & Son Ltd. (1986), incorporated herein by reference. In another non-limiting aspect of the exemplary embodiment, exemplary single crystal growing techniques are the Bridgman-Stockbarger method, the Czochralski method, the “zone-melting” (or “floating-zone”) method and the “temperature gradient” method.

In another non-limiting exemplary embodiment technique for preparing a single crystal of the exemplary embodiment scintillator material, U.S. Pat. No. 6,585,913 (Lyons et. al.) is herein incorporated by reference. In this non-limiting exemplary embodiment technique, a seed crystal of the desired exemplary embodiment scintillator composition 100 is introduced into a saturated solution. In another aspect of the exemplary embodiment technique, the saturated solution is contained in a suitable crucible and contains appropriate precursors for the scintillator composition 100. The exemplary embodiment technique continues by allowing the exemplary embodiment scintillator composition 100 crystal to grow and add to the single crystal, using one of the growing techniques discussed previously and the growth stopped at the point the exemplary embodiment scintillator composition 100 crystal reaches a size suitable for the intended application.

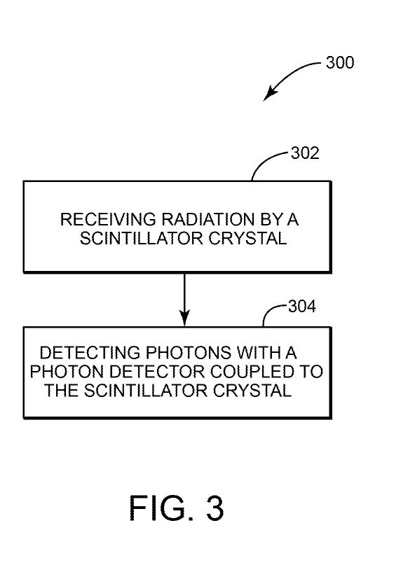

Looking now to FIG. 2 and another exemplary embodiment, an apparatus for detecting high-energy radiation with a scintillation radiation detector 200 is described. In the exemplary embodiment, the scintillation radiation detector 200 includes one or more scintillator composition crystals 202, formed from the scintillator composition 100 described herein. Scintillation radiation detectors 200 are well-known in the art, and need not be described in detail here. Several non-limiting references discussing such devices are U.S. Pat. Nos. 6,585,913 and 6,437,336 described above and U.S. Pat. No. 6,624,420 (Chai et. al.), which is also incorporated herein by reference. In another exemplary embodiment illustrated in FIG. 3, a method for detecting high-energy radiation with a scintillation radiation detector 200 is described. In a first step 302, the scintillator composition 100 crystals 202 in these devices receive radiation from a source being investigated, and produce photons which are characteristic of the radiation. In the next step 304, the photons are detected with some type of photon detector, known as a photodetector 204, coupled to the scintillator composition 100 crystal 202 by conventional electronic and mechanical attachment systems.

The photodetector 204 can be a variety of devices, all well-known in the art. Non-limiting examples include photomultiplier tubes, photodiodes, CCD sensors, and image intensifiers. The choice of a particular photodetector 204 will depend in part on the type of radiation detector 200 being constructed and on the radiation detector's 200 intended use.

The radiation detectors 200 themselves, which include the scintillator composition 100 crystal 202 and the photodetector 204, can be connected to a variety of tools and devices. Non-limiting examples include well-logging tools and nuclear medicine devices. In another non-limiting example, the radiation detectors 200 can be connected to digital imaging equipment. In a further exemplary embodiment, the scintillator composition 100 crystal 202 can serve as a component of a screen scintillator.

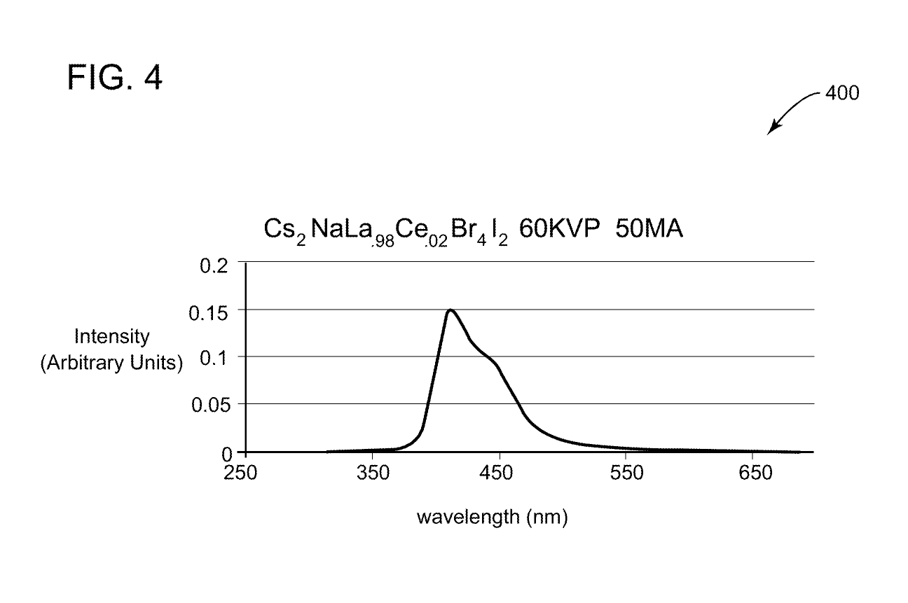

The emission spectrum for a sample of the scintillator composition 100 was determined under X-ray excitation, using an optical spectrometer. FIG. 4 is a plot of wavelength (nm) as a function of intensity (arbitrary units). The peak emission wavelength for the sample was about 365 nm. It was also determined that the scintillator composition 100 can be excited by gamma rays, to an emission level that is characteristic of the cerium ion. These emission characteristics are a clear indication that the compositions described herein would be very useful for a variety of devices employed to detect gamma rays.

The disclosed exemplary embodiments provide descriptions of a new scintillator composition 100 and existing methods for preparing the new scintillator composition 100. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

This written description uses examples to disclose the new scintillator composition 100, including the best mode, and also to enable any person skilled in the art to prepare the new scintillator composition 100 based on existing techniques, including making the scintillator composition 100 as a single crystal. The patentable scope of the scintillator composition 100 is defined by the claims, and may include other examples that occur to those skilled in the art. Such other examples are intended to be within the scope of the claims if they have structural elements that do not differ from the literal language of the claims, or if they include equivalent structural elements to those recited in the literal languages of the claims.

What is claimed is:

1. A scintillator composition comprising the following and any reaction products thereof:
a matrix material comprising:
a first component of at least one element selected from the group consisting of alkali metals and thallium;
a second component of at least one element, different from the at least one element of the first component, selected from the group consisting of alkali metals;
a third component of at least one element selected from the group consisting of lanthanides; and
a fourth component of at least two elements selected from the group consisting of halogens; and
an activator for the matrix material, comprising cerium.

2. The scintillator composition of claim 1, wherein the alkali metal of the first component is selected from the group consisting of potassium, rubidium, cesium and combinations thereof.

3. The scintillator composition of claim 1, wherein the alkali metal of the second component is selected from the group consisting of lithium, sodium and combinations thereof.

4. The scintillator composition of claim 1, wherein said lanthanide of the third component is lanthanum.

5. The scintillator composition of claim 1, wherein the halogens of the fourth component are selected from the group consisting of fluorine, chlorine, bromine, iodine and combinations thereof

6. The scintillator composition of claim 1, wherein the halogens of the fourth component are bromine and iodine in a ratio of two to one, respectively.

7. The scintillator composition of claim 1, wherein the activator is present at a level in the range of about 1 mole percent to about 20 mole percent, based on total moles of activator and matrix material.

8. The scintillator composition of claim 1, wherein the matrix material comprises a compound of the formula A₂BLnX₆, wherein:
A is at least one element selected from the group consisting of alkali metals and thallium;
B is at least one element, different from the A element, selected from the group consisting of alkali metals;
Ln is at least one element selected from the group consisting of lanthanides; and
X is at least two elements selected from the group consisting of halogens, and combinations thereof.

9. The scintillator composition of claim 8, wherein Ln is lanthanum.

10. The scintillator composition of claim 8, wherein X is bromine and iodine in a ratio of two to one, respectively.

11. The scintillator composition of claim 1, wherein the matrix material further comprises bismuth.

12. The scintillator composition of claim 11, wherein the bismuth is present at a level of about 1 mole percent to about 40 mole percent, based on total moles of activator and matrix material.

13. The scintillator composition of claim 1, wherein the matrix material comprises at least one compound selected from the group consisting of Cs₂NaLaBr₅I, Cs₂NaLaBr₄I₂, Cs₂NaLaBr₃I₃, Cs₂NaLaBr₂I₄, Cs₂NaLaBr₁I₅; and Cs₂Na(La₁₋ₓCeₓ)Br₄I₂, wherein 0.01≦x≦1.00.

14. A radiation detector apparatus for detecting high-energy radiation, the apparatus comprising:
a crystal scintillator, which comprises the following composition, and any reaction products thereof:
a matrix material, comprising:
a first component of at least one element selected from the group consisting of alkali metals and thallium;
a second component of at least one element, different from the at least
one element of the first component, selected from the group consisting of alkali metals;
a third component of at least one element selected from the group consisting of lanthanides; and
a fourth component of at least two elements selected from the group consisting of halogens; and
an activator for the matrix material, comprising cerium; and
a photodetector optically coupled to the crystal scintillator and configured to produce an electrical signal in response to the emission of a light pulse produced by the crystal scintillator.

15. The radiation detector apparatus of claim 14, wherein the alkali metal of the first component is selected from the group consisting of potassium, rubidium, cesium and combinations thereof.

16. The radiation detector apparatus of claim 14, wherein the alkali metal of the second component is selected from the group consisting of lithium, sodium and combinations thereof.

17. The radiation detector apparatus of claim 14, wherein the lanthanides of the third component is lanthanum.

18. The radiation detector apparatus of claim 14, wherein the halogens of the fourth component are selected from the group consisting of fluorine, chlorine, bromine, iodine and combinations thereof.

19. A method for detecting high-energy radiation with a scintillation detector, the method comprising:
receiving radiation by a scintillator crystal, so as to produce photons which are characteristic of the radiation; and
detecting the photons with a photon detector coupled to the scintillator crystal;
wherein the scintillator crystal is formed of a composition comprising the following, and any reaction products thereof:
a matrix material, comprising:
a first component of at least one element selected from the group consisting of alkali metals and thallium;
a second component of at least one element, different from the at least one element of the first component, selected from the group consisting of alkali metals;
a third component of at least one element selected from the group consisting of lanthanides; and
a fourth component of at least two elements selected from the group consisting of halogens; and
an activator for the matrix material, comprising cerium.

20. The method of claim 19, wherein the matrix material comprises a compound of the formula A₂BLnX₆ wherein:
A is at least one element selected from the group consisting of alkali metals and thallium;
B is at least one element, different from the A element, selected from the group consisting of alkali metals;
Ln is at least one element selected from the group consisting of lanthanides; and
X is at least two elements selected from the group consisting of halogens, and combinations thereof.
